(19) United States
(12) Patent Application Publication
(10) Pub. No.: US 2009/0100329 A1
(43) Pub. Date: Apr. 16, 2009

(54) Method of Deploying a Web Widget In a Desktop Widget Platform

(76) Inventor: Danny Javier Espinoza, Washington, DC (US)

Correspondence Address: Danny J. Espinoza, c/o Mesa Dynamics, LLC, 5505 Connecticut Avenue, NW #235, Washington, DC, 20015, US

(21) Appl. No.: 12/246,482

(22) Filed: Oct. 6, 2008

Related U.S. Application Data
(60) Provisional application No. 60/977,601, filed on Oct. 4, 2007.

(51) Int. Cl. G06F 17/00

(52) U.S. Cl. 715/234

(57) ABSTRACT

One embodiment of a method is described for deploying a web widget, intended for use inside a web browser, in a desktop widget platform by way of a widget template modified to load the content of the web widget. The widget template is created according to the development specification of a specific desktop widget platform using generic properties and a placeholder in the source code for displaying HTML content. For any particular web widget, the generic properties of the template are modified to reflect the specific properties inferred by the web widget snippet, the placeholder is replaced with the snippet, and the resulting modified widget template is prepared for installation into the desktop widget platform where it will be deployed as a desktop widget. Other embodiments are described and presented.

This application claims priority to provisional application No. 60/977,601 filed Oct. 4, 2007 by the present inventor and entitled “A Method of Deploying a Web Widget in a Desktop Widget Platform,” which is incorporated by reference.

### FIELD OF THE INVENTION

The present invention relates generally to computer software, and specifically to the deployment of a web widget, intended for use inside a web browser, to a desktop widget platform.

### BACKGROUND

Notwithstanding their shared use of the term “widget,” web widget and desktop widget technologies are not interoperable.

A web widget is deployed inside a web page on the World Wide Web. Typically, some users act as providers, adding web widgets to web pages they have permission to modify (e.g., personal home pages, blogs, social networking profiles, etc.). Other users act as consumers, directing their web browsers to web pages in which web widgets have been deployed. Thus, the nature of web widget deployment leads to various technical limitations and constraints, such as:
a. Only providers can deploy web widgets.
b. Consumers can use web widgets only from within the confines of a web browser.
c. Providers control consumer access to web widgets.

In contrast, a desktop widget is deployed in a desktop widget platform on a personal computer. Users who download and install desktop widgets act as both providers and consumers, using their desktop widgets on their own computer desktops and controlling their own access to their desktop widgets.

Web widget publishers who wish to broaden their consumer reach are forced make their web widgets deployable in desktop widget form by rewriting their web widgets to adhere to the development specification for each specific desktop widget platform they wish to target. Such an undertaking is resource intensive and cumbersome, especially considering (1) the large size of most web widget libraries, and (2) the existence of at least three major desktop widget platforms in wide release (Windows Vista Sidebar, Apple Dashboard and Yahoo! Widget Engine), each with its own unique development specification. Indeed, because of these significant obstacles, most web widget publishers choose not to release desktop widget versions of their widgets.

### SUMMARY OF THE INVENTION

In accordance with one embodiment of the present invention, a widget template for a specific desktop widget platform is created, modified to display the content of a specific web widget and prepared for installation in such platform.

### DRAWINGS

### Figures

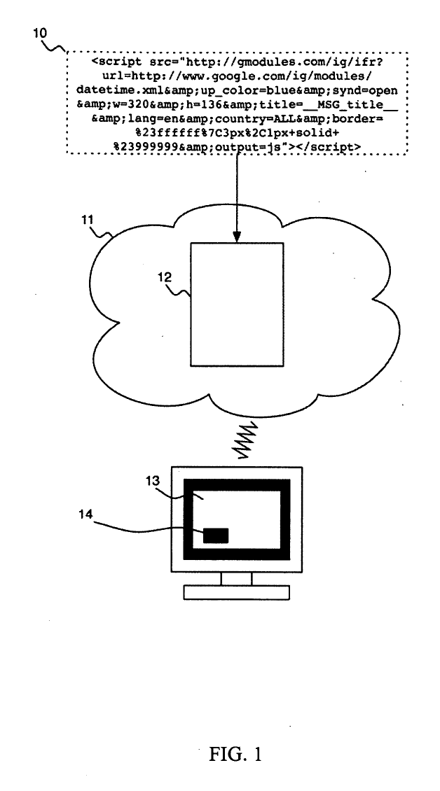

FIG. 1 illustrates the components of a typical web widget deployment.

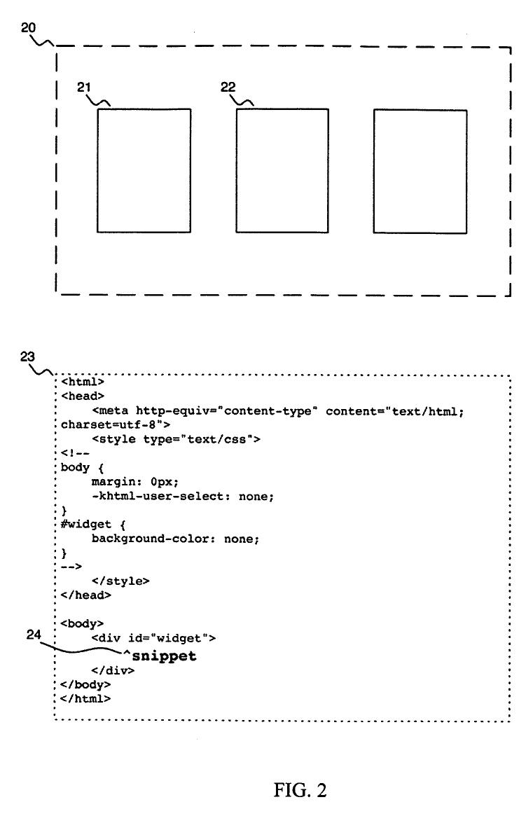

FIG. 2 illustrates the components of a widget template, according to one embodiment of the present invention.

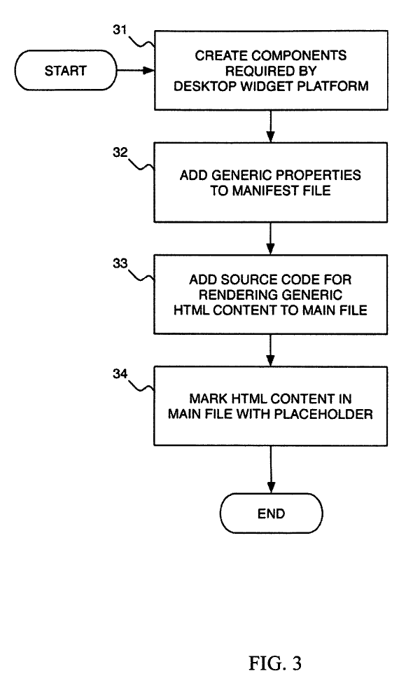

FIG. 3 illustrates the operations comprising creation of a widget template for a specific desktop widget platform, according to one embodiment of the present invention.

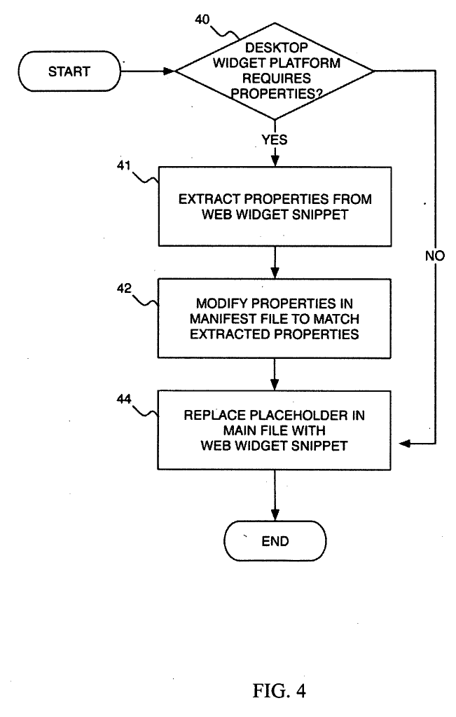

FIG. 4 illustrates the operations comprising modification of a widget template to display the content of a specific web widget, according to one embodiment of the present invention.

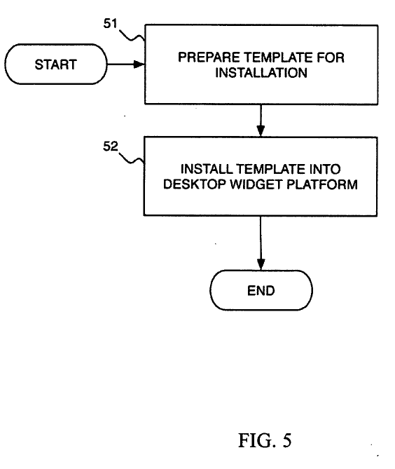

FIG. 5 illustrates the operations comprising deployment of a widget temple in a specific desktop widget platform, according to one embodiment of the present invention.

### DRAWINGS

### Summary of Components

10 snippet
11 computer network
12 source code (web page)
13 web browser
14 web widget
20 archive
21 main file
22 manifest file
23 source code (desktop widget)
24 placeholder

### DESCRIPTION OF TERMS

A widget is a mini-application: a self-contained interactive module that displays information and a user-interface in a small section of a computer screen. Types of widgets include, for example, video games, local weather reports, news feeds, photo slideshows and video clips.

A web widget is a widget displayed in a web browser, typically in a frame embedded in a web page.

A desktop widget is a widget displayed in a moveable window located within a computer's desktop window environment.

A desktop widget platform (or platform) is a software application that allows a user to manage, position and display multiple desktop widgets, independent of other applications that may be running on the computer system.

A snippet is a string of code intended for insertion into the source code of a destination web page.

An archive is a compressed file containing a collection of components (i.e., other files and folders).

A development specification (or specification) defines the components required to build a desktop widget for a given platform including, without limitation, the computer language(s), Application Programming Interface(s), file format(s) and data structure(s) to utilize when creating the individual components.

A widget template (or template) is an archive containing the components required for a desktop widget, adhering to the specification of a given desktop widget platform.

### Description of the Invention—Preferred Embodiment

The present invention can be applied to any web widget deployed as illustrated in FIG. 1. A snippet 10 of HTML source code is published on the web for insertion into the source code 12 of a web page on a computer network 11 such as, but not limited to, the World Wide Web. When the modified web page is viewed in a web browser 13, the snippet 10 directs the web browser 13 to load additional source code, representing the web content, from the network and into a frame 14 embedded in the web page.

The present invention describes the assembly of a template illustrated in FIG. 2. An archive 20 is comprised of the components required for a desktop widget, adhering to the specification of a specific desktop widget platform. The archive 20 includes a manifest file 22, enumerating various properties of the desktop widget, and a main file 21, containing source code 23 to be executed when the desktop widget, installed in the widget platform, is opened. The source code 23 contains a placeholder 24 representing a location to insert HTML source code.

### Operation of the Invention—Preferred Embodiment

The present invention is executed in three steps:

Step 1: Creation of a Widget Template for a Specific Desktop Widget Platform

A specific desktop widget platform is identified as a destination for web widget deployment.

Adhering to the development specification of the desktop widget platform, the required components for a desktop widget including, but not limited to, a manifest file 22 and a main file 21 are created (FIG. 3, 31) and assembled into an archive 20. The method of creating and assembling these components will be well known to those with ordinary skill in desktop widget development.

Because the archive 20 is the basis for a widget template (representing a generic widget with undefined content as opposed to a specific widget with defined content), generic properties are added (FIG. 3, 32) to the manifest file 22 (e.g., setting the width and height to 100 pixels each, setting the title to “Untitled”, etc.).

Adhering to the development specification of the desktop widget platform, the source code 23 in the main file 21 is written (FIG. 3, 33) to render generic HTML content into the window of a desktop widget.

Because the content to be displayed in the widget template is undefined, the location of the generic HTML content in the source code 23 is marked (FIG. 3, 34) with a text placeholder 24 (e.g. “̂snippet”) representing the insertion point for specific HTML source code.

Step 2: Modification of the Widget Template to Display the Content of a Specific Web Widget

A specific web widget 14 is identified for deployment in a specific desktop widget platform and its respective snippet 10 is copied and ready for use. A widget template whose components adhere to the development specification of the platform has been prepared per the previous section.

If the platform's development specification requires the expression of specific desktop widget properties (FIG. 4, 40), any such properties are extracted (FIG. 4, 41) from the snippet 10, if possible, and used to modify, replace or augment (FIG. 4, 42) respective generic properties of the manifest file 22. For example, if the development specification requires the expression of a specific widget width, then the value of this property may be determined by intelligent parsing of the snippet 10 (e.g., the snippet in FIG. 1 has its width encoded as “w=320”) and used in place of the value of the generic widget width property (e.g. a width of 100 pixels) in the manifest file 22. The method of parsing these properties will be well known to those with ordinary skill in computer science.

Because the content to be displayed in the widget template is now defined, the placeholder 24 in the source code 23 of the main file 21 is replaced (FIG. 4, 44) with the snippet 10.

These modifications in effect “wrap” the content of a specific web widget 14 inside components that adhere to the development specification of the specific desktop widget platform.

Step 3: Deployment of the Modified Widget Template in a Specific Desktop Widget Platform

A modified widget template whose components adhere to the development specification of the platform has been modified to display the contents of a specific web widget per the previous section.

The modified widget template is prepared for installation (FIG. 5, 51) according to the requirements of the platform's development specification. This may include additional modifications such as, but not limited to, compressing the archive 20, renaming the archive 20 and generating a unique widget identifier for addition to the manifest file 22. The prepared widget template is installed (FIG. 5, 52) in the specific desktop widget platform in the manner prescribed by the platform's development specification.

After the prepared widget template is installed and opened in the desktop widget platform, the snippet 10 directs the platform 13 to load additional source code, representing the content of the web widget, inside the window of a desktop widget whose properties match those of the web widget.

### OTHER EMBODIMENTS

In the preferred embodiment, the snippet 10 is comprised of HTML source code. However, the snippet may be comprised of any code that can be represented in string form including, but not limited to, JavaScript and PHP. Furthermore, the additional source code referred to by the snippet may be comprised of any code that is executable by a web browser including, but not limited to, Flash, Java, JavaScript and PHP.

In the preferred embodiment, specific widget properties are extracted from the snippet 10. These properties may also be determined or computed by other methods including, but not limited to: (1) parsing resources either directly or indirectly referenced by the snippet 10; (2) parsing resources either directly or indirectly referenced by the by the web page from which the snippet 10 was copied; (3) looking up properties in a table; (4) performing a database query; (5) making an HTTP or other network request; or (6) as arguments passed into a code function.

The actual deployment illustrated in FIG. 5 of the prepared widget template is optional, and may be deferred or omitted from some embodiments of the present invention.

Other embodiments of the present invention include:

The manifest file 22 and main file 21 may be one and the same.

The manifest file 22 and/or the main file 21 may be distributed over multiple components in the archive 20.

The snippet 10 may be subdivided, restructured, augmented or modified to form multiple snippets, each replacing multiple placeholders in one or more components in the archive 20.

The source code 23 may be written in such a manner to perform some or all of the operations illustrated in FIG. 4 dynamically, at runtime, after the widget template has been installed in the specific desktop widget platform.

The creation of the widget template and subsequent modification of the template as illustrated in FIGS. 3 and 4 may be performed in parallel and thus combined into one step.

The widget template resulting from the operations illustrated in FIG. 3 may be reused for future iterations of the present invention that target the same desktop widget platform.

The modified widget template resulting from the operations illustrated in FIG. 4 may be reused for future iterations of the present invention that target the same web widget and same desktop widget platform.

### CONCLUSION AND RAMIFICATIONS

Accordingly, web widget publishers can use the present invention to efficiently deploy their widget libraries en masse to a specific desktop widget platform, avoiding costly and time-consuming rewrites of their widgets. This strategy offers a number of additional advantages benefiting both publishers and users:
a. Users can use, manage or store web widgets alongside their desktop widgets.
b. The user experience for a web widget and its desktop widget version is substantially identical.
c. Web widget publishers can broaden the consumer reach for their web widgets.
d. Updates and bug fixes made to web widgets are automatically propagated to their desktop widget versions.

### SCOPE

The flowcharts in FIGS. 3-5 illustrate the present invention as previously described.

The present invention is described in terms of the above embodiments. This is for convenience only and is not intended to limit the application of the present invention. In fact, after reading the description of the present invention, it will be apparent to one skilled in the relevant arts how to implement the present invention in alternative embodiments.

In addition, it should be understood that FIGS. 1-5 described above are presented for example purposes only. The architecture of the present invention is sufficiently flexible and configurable, such that it may be utilized in ways other than that shown in FIGS. 1-5.

What is claimed is:

1. A method of deploying a web widget in a desktop widget platform, comprising:
a. creating a widget template which adheres to the development specification of said platform,
b. providing said template means for displaying web content,
c. substituting generic properties expressed in said template with specific, respective properties of said web widget,
whereby a user, who has installed and opened said template in said platform, can access substantial functionality of said web widget.
